(19) United States
(12) Patent Application Publication
(10) Pub. No.: US 2009/0303709 A1
(43) Pub. Date: Dec. 10, 2009

(54) Blended Color LED Lamp

(76) Inventor: Richard Weatherley, Northampton (GB)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/477,286

(22) Filed: Jun. 3, 2009

(30) Foreign Application Priority Data
Jun. 4, 2008 (GB) 0810226.1

(51) Int. Cl. F21V 9/00

(52) U.S. Cl. 362/231

(57) ABSTRACT

An LED based light bulb comprises a ring 1 of six LEDs arranged around a seventh LED 2 located in the centre of the ring 1. The LEDs forming the ring are selected in equal numbers from two groups, each group comprising LEDs which emit light falling within an associated wavelength range, the associated wavelength range being different for each group. The LEDs 1A from the first group are alternated around the ring with LEDs 1B from the second group in a 1A-1B-1A-1B-1A-1B pattern. The seventh LED 2 is selected from a group different to either of the groups from which the LEDs forming the ring are selected.

### CROSS-REFERENCE TO RELATED APPLICATIONS

This application claims priority to United Kingdom Patent Application GB 0810226.1, filed on Jun. 4, 2008, the disclosure of which is incorporated herein by reference in its entirety.

### FIELD OF THE INVENTION

The present invention relates to a improvements in the formation of light emitting diode (LED) based lamps so as to improve consistency and light between different bulbs.

### BACKGROUND OF THE INVENTION

LEDs are increasingly nowadays being used in place of conventional filament or halogen type bulbs in a wide variety of applications, primarily due to their longer life and more efficient power consumption. Because the light omitted by an LED is typically much dimmer than that of a filament or halogen type bulb, it is normally necessary to implement a design which incorporates multiple LEDs so as to ensure that an adequate level of light is obtained from the bulb.

When individual LEDs are made, it is very difficult to maintain consistent colors within a particular production batch, yet alone across production batches. The doping of the semiconductor material, which is what dictates the color of light produced by the resulting LED, is notoriously difficult to accurately maintain, and this is but one factor which effects the color of the light resulting from the LED. Other factors include the phosphor coating which is included in the LED. As a result, at the end of the production process, each LED is tested to identify the wavelength of light omitted thereby, and the LEDs are “binned” into groups which share a common wavelength band—all LEDs in a particular group, for example, might have a wavelength within 5 to 10 nanometers of each other. The range in each group is dictated by what the observer will distinguish as a different color-consistency of color being important for the end user. For production runs of, say 10,000 LEDs might produce seven “bins” each containing on average 1,400 LEDs and the customer then has the option of how he sources the LEDs. If it is important to the customer to have close control on consistency of light, they can elect to have LEDs all from the same bin, or they can elect to have LEDs from a number of bins. The more bins which are used to source the LEDs, the lower the cost, but the customer using the individual LEDs in groups to make, for example, bulbs, then faces the problem that they will have a lower number of bulbs of each color which can be used to form “matched bulbs”.

It is also known in the art to produce LED bulbs which have individual LEDs of different colors which can then be operated to produce light of any particular color which is required. This is achieved by having bulbs of different colors operated by a different driver (power source). By suitable operation of the different drivers, the light can be mixed in different levels to produce any color required by the end user.

### SUMMARY OF THE INVENTION

According to a first aspect of the present invention there is provided an LED based light bulb incorporating a plurality of individual LEDs all connected in series and powered by a common driver, the LEDs being formed into at least two groups, each group comprising LEDs which emit light falling within an associated wavelength range, the associated wavelength range being different for each group, the LEDs from the groups being arranged in a pattern such that the light from the LEDs is mixed so as to produce a blended light.

A bulb in accordance with embodiments of the present invention has the advantage that, by actively selecting LEDs having different wavelength bands and incorporating them into a bulb in a predefined pattern, the color of the light produced by the resulting bulbs can be much more consistently maintained within bulbs made from the same and different batches of LEDs due to the fact that the mixing of the different lights nulls the slight difference in light colors which is emitted by each LED. Furthermore, because each LED bulb is produced from LEDs from at least two groups, then at least double the amount of matched bulbs can be produced, by matched it is meant that they will emit a blended light which, to the observer, will be seen to be the same for each bulb, as compared with the prior art system where LEDs from only a single source were chosen. In the above mentioned example of a 10,000 LED run, if LEDs from just a single bin were utilized, and seven LEDs were required for each bulb, then just 200 matched bulbs of each color could be produced. In contrast, with embodiments of the present invention, if LEDs from two bins are utilized, then twice the number of matched bulbs of a particular color can be produced from that batch. Moreover, as indicated above, the system has the advantage that the color is more closely matched between different LED manufacturing runs.

Embodiments of the present invention also provide a method of manufacturing an LED based bulb comprising selecting a first plurality of LEDs having a wavelength falling within a first wavelength range, selecting at least a second plurality of LEDs having a wavelength falling within a second wavelength range, laying out said LEDs in a predefined pattern, then connecting said LEDs in series and powering said LEDs with a common driver.

Typically, in an LED based bulb, the LEDs are arranged in either a single ring around a single central LED, or in a number of concentric rings of decreasing numbers of LEDs again around a single central LED. In one embodiment of the present invention, the ring is formed by alternating LEDs of different wavelengths from within at least two groups, and then placing in the middle an LED from a further group which has a different wavelength range from any of the LEDs in the or each ring. In particular, in one preferred embodiment, the bulb is formed from seven LEDs composed of six LEDs in a ring around a single seventh LED. The ring is formed by alternating LEDs of a first and second wavelength range and then positioning in the centre and a single LED of a third wavelength range. In a further alternative, the ring is formed from LEDs of three wavelength ranges alternated in a pattern 123123, with the seventh LED in the centre having a wavelength selected from a fourth wavelength range. It will, of course, be understood that a number of different configurations are possible depending on the number of different wavelength range LEDs it is desired or acceptable to use. However, it is preferable that, whatever the number of bin sources for the LEDs, the LED pattern is always arranged to alternate in sequence the LEDs having different wavelength bands, with an equal number of LEDs from each group being arranged in each ring, and to configure in the middle of the ring an LED having a wavelength band which is different from the wavelength band of any of the LEDs at least in the ring immediately adjacent the centre LED.

### BRIEF DESCRIPTION OF THE DRAWINGS

In order that the present invention may be well understood, there will now be described some embodiments thereof, given by way of example, reference being made to the accompanying drawings in which:

FIG. 1 is a schematic illustration of an LED pattern according to a first embodiment of the present invention; and

FIG. 2 is a schematic illustration of an LED light pattern of a bulb according to a second embodiment of the present invention.

### DETAILED DESCRIPTION

The present invention will now be described with reference to the drawing figures, in which like reference numerals refer to like parts throughout.

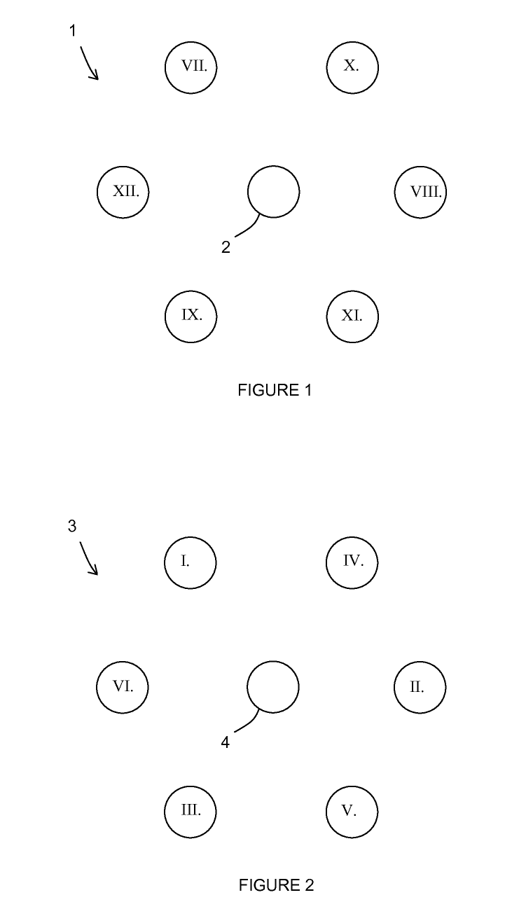

Referring first to FIG. 1, there is shown a schematic illustration of an LED distribution pattern of a typical bulb which is composed of seven LEDs. The seven LEDs are configured with six of the LEDs being arranged in a ring 1 about a seventh LED 2. In common with prior art systems, the LEDs are mounted on a common circuit board and connected in series so that operation of a single power source effects illumination of all seven LEDs with a common current.

The seven LEDs which form the bulb are formed into three groups, each group having a different wavelength range. The outer ring 1 of LEDs is formed of three LEDs 1A emitting light which falls within a first wavelength range and three LEDs 1B which emits light falling within a second wavelength range which is different from said first wavelength range. The LEDs from the two groups are alternated in the ring so that each LED 1A from one group is bound on each side by an LED 1B from the other group. The LED 2 in the centre of the ring is chosen to emit light having a wavelength which falls within a range which is different from the light emitted from either the LEDs from the first group or from the second group. In this way, the light emitted by a bulb is perceived by the viewer to have a color which is of a single color which is a blend of the light colors emitted by the different LEDs—the user does not perceive the fact that the bulb is made up of LEDs having different colors. In particular, even if he were to look directly at the LEDs the brightness of the light will prevent him from reconciling the different colors of the LEDs. As a result, the resulting bulbs can be produced with much more consistent color than with the prior art system and at the same time at a much more reasonable cost because they are produced from LEDs from a wider range of bin sources.

FIG. 2 shows an alternative embodiment, again comprising a bulb formed of seven LEDs-six LEDs in a ring around a seventh, but in this case, the LEDs are chosen from four different bins, i.e. emit light having a wavelength falling in to four different ranges. Again, the central LED 4 is chosen to be one which emits light falling within a wavelength range which is different from the light emitted by any of the LEDs in the ring 3. The six LEDs forming the ring 3 are then separated into three groups each containing two LEDs each group again being chosen to emit light falling in a particular wavelength range which is different from the others. In this case, the LEDs are again distributed sequentially around the ring so that each LED from one group is bound on either side from an LED from each of the other groups. All seven LEDs are, again, connected in series and powered by a common driver/power source. The light resulting from the bulb according to the second embodiment will have a different color to that of the first embodiment but will again be much more consistent between bulbs compared with prior art systems and by view of the fact that the seven LEDs are chosen from four bins, it will be possible to obtain an even greater number of completed bulbs from each production run and at the same time, again because a wider range of bin sources are used, the costs are likely to be even lower.

It will, of course, be understood that, whilst the described example uses seven LEDs, configurations using more or less than seven LEDs could also be used. It is important that each ring of LEDs is formed of an equal number of LEDs from each bin (that is having a particular wavelength range) but it is possible that LEDs in different rings could be selected from different groups. For example, in an arrangement having two concentric rings around a single central LED, the outer ring may be formed of LEDs emitting light of a first wavelength range and the inner ring formed of LEDs emitting a second wavelength range, or each ring may be formed of a plurality of LEDs falling within different groups as described above in relation to FIGS. 1 and 2, the two rings optionally being formed either from LEDs falling within the same groups or from LEDs falling within different groups.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. An LED based light bulb comprising a plurality of individual LEDs all connected in series and powered by a common driver, the LEDs being formed into at least two groups, each group comprising LEDs which emit light falling within an associated wavelength range, the associated wavelength range being different for each group, the LEDs from the groups being arranged in a pattern such that the light from the LEDs is mixed so as to produce a blended light.

2. A light bulb according to claim 1, wherein at least some of said LEDs are arranged in at least one ring, the or each ring being formed by alternating LEDs selected from at least two groups.

3. A light bulb according to claim 2, wherein the or each ring is contains an equal number of LEDs from each selected group in the said ring.

4. A light bulb according to claim 2, wherein the or each ring encircles a single, central common LED,

5. A light bulb according to claim 4, wherein the central LED is selected from a group different to the groups from which the LEDs in the ring immediately surrounding said central LED are selected.

6. A light bulb according to claim 3, wherein 6 LEDs are arranged in a ring around a single, seventh LED.

7. A light bulb according to claim 6, wherein the 6 LEDs forming the ring are selected in equal numbers from two different groups, the LEDs from different groups alternating around the ring so that each LED from one group is positioned between two LEDs from the other group, and wherein the seventh LED positioned in the middle of the ring is selected from a third group different from said groups from which the LEDs forming the ring are selected.

8. A light bulb according to claim 6, wherein the 6 LEDs forming the ring are selected in equal numbers from three different groups, the LEDs from different groups alternating around the ring in a pattern 123123, and wherein the seventh central LED is selected from a fourth group different from the groups from which the ring LEDs are selected.

9. A method of manufacturing an LED based bulb comprising selecting a first plurality of LEDs having a wavelength falling within a first wavelength range, selecting at least a second plurality of LEDs having a wavelength falling within a second wavelength range, laying out said LEDs in a predefined pattern, then connecting said LEDs in series and powering said LEDs with a common driver.

10. A method according to claim 9, comprising the further step of arranging at least some of said LEDs in at least one ring, the or each ring being formed by alternating LEDs from at least two groups.

11. A method according to claim 10, comprising the further step of using an equal number of LEDs from each selected group to form the or each ring.

12. A method according to claim 10, comprising the further step of positioning a single, central common LED in the centre of the ring.

13. A method according to claim 12, comprising the further step of selecting the central LED from a group different to the groups from which the LEDs in the ring immediately surrounding said central LED are selected.

14. A method according to claim 13, comprising the further step of selecting 6 LEDs, three each from two different groups, and using said 6 LEDs to form the ring by alternating LEDs from the two groups so that each LED from one group is positioned between two LEDs from the other group; selecting a seventh LED from a third group different from said groups from which the LEDs forming the ring are selected; and positioning said seventh LED in the centre of said ring of 6 LEDs.

15. A method according to claim 13, comprising the further step of selecting 6 LEDs, two each from three different groups, and using said 6 LEDs to form the ring by alternating LEDs from the three groups around the ring in a pattern 123123; selecting a seventh LED from a fourth group different from said groups from which the LEDs forming the ring are selected; and positioning said seventh LED in the centre of said ring of 6 LEDs.
